(19) United States
(12) Patent Application Publication
(10) Pub. No.: US 2015/0281968 A1
(43) Pub. Date: Oct. 1, 2015

(54) Exploiting the Bessel Functions in Communication Systems

(71) Applicant: Omid Aryan, Stanford, CA (US)

(72) Inventor: Omid Aryan, Stanford, CA (US)

(73) Assignee: Omid Aryan, Stanford, CA (US)

(21) Appl. No.: 14/673,005

(22) Filed: Mar. 30, 2015

Related U.S. Application Data
(60) Provisional application No. 61/972,416, filed on Mar. 31, 2014.

(51) Int. Cl. H04W 12/08; H04L 29/06

(52) U.S. Cl. CPC H04W 12/08; H04L 63/0428

(57) ABSTRACT

The present invention provides a modulation scheme based on the Bessel functions. Two general schemes are provided for multiplexing signals: in one scheme users shared a frequency band to operate on and in the other a separate frequency band was assigned to each user. The present invention also provides an encryption scheme based on these functions that is a natural consequence of the aforementioned modulation schemes.

### 1 CROSS-REFERENCE TO RELATED APPLICATIONS

This application claims the benefit of U.S. Provisional Application No. 61/972,416, filed Mar. 31, 2014.

### 2 STATEMENT REGARDING FEDERALLY SPONSORED RESEARCH OR DEVELOPMENT

Not Applicable

### 3 REFERENCE TO SEQUENCE LISTING, A TABLE, OR A COMPUTER PROGRAM LISTING COMPACT DISK APPENDIX

Not Applicable

### 4 FIELD OF THE INVENTION

The present invention relates to the field of wireless technologies and to the field of communication systems in general.

### 5 SUMMARY

In one embodiment of the present invention, a modulation scheme is provided that modulates communication signals via the Bessel functions. In a second embodiment of the present invention, an encryption technique is provided that exploits the mathematical properties of the Bessel functions when these functions are used for the purposes of modulating communication signals.

### 6 BRIEF DESCRIPTION OF THE DRAWINGS

FIG. 1: Bessel functions of the first kind for orders 0, 1, 2, 3, 4, and 5.

FIG. 2: Multi-user system model.

FIG. 3: Approach 1: users share the same frequency band.

FIG. 4: Approach 2: each user is assigned its own frequency band.

### 7 BACKGROUND

Perhaps the most fundamental mathematical ingredient to wireless communications and communication systems in general is the widely known sinusoidal functions. These functions provide for the orthogonal basis of the signal space of wireless transmissions and have played this role ever since the first radio transmission. The popularity of these functions in communications has in part been due to the practicality of generating them using electronic circuits (especially with those used in the early days of wireless). Another merit is the mathematical maturity that exists for sinusoidal functions and the ease with which they can be mathematically comprehended. As a result, engineers have relied on these functions and developed numerous techniques of manipulating them in order to generate signals that are robust to communication channels and at the same time carry the most information possible.

Nevertheless, hardware performance has come a long way since the early days of radio. This reality begs the question: why not explore other basis functions as our foundation? Why limit ourselves to sines and cosines? The present invention takes a step towards realizing this vision by exploiting the Bessel functions as an alternative set of basis functions for the purposes of communications.

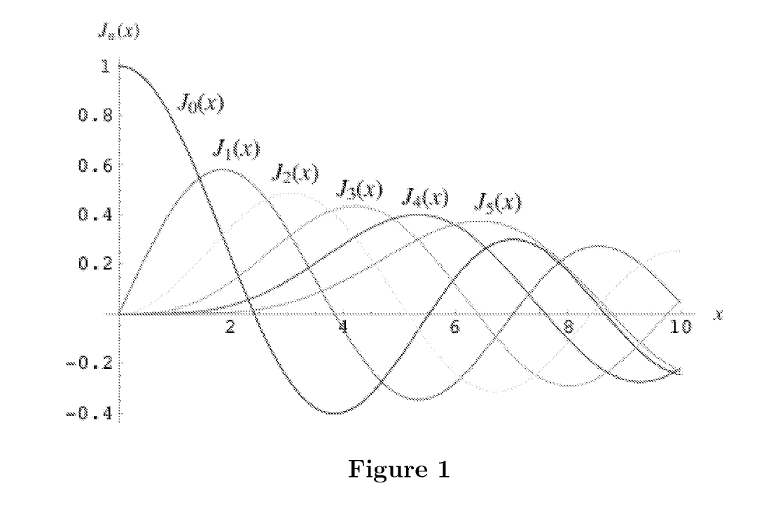

The present invention exploits a specific class of the Bessel functions, namely the Bessel functions of the first kind, Jₙ(x), which are defined to be the solutions to the following differential equation:

$${x}^{2} \frac{{d}^{2} y}{d {x}^{2}} + x \frac{d y}{d x} + ( {x}^{2} - {n}^{2} ) y = 0 \qquad ( 1 )$$

where n is the order of the Bessel function. FIG. 1 shows a plot of Jₙ(x) for n 0, 1, 2, . . . , 5 (which was obtained from [9]).

Suppose we have Jₘ(a)=0 and Jₘ(b)=0, for some integer m. Hence, a and b are two roots of the Bessel function of order m. If a≠b, it can be shown that

∫₀¹xJₘ(ax)Jₘ(bx)dx=0 (2)

Furthermore, if a=b we have

$${\int }_{0}^{1} {xJ}_{m}^{2} ( ax ) d x = \frac{1}{2} {J}_{m + 1}^{2} ( a ) \qquad ( 3 )$$

Hence, we define the inner product of the two Bessel functions Jₘ(ax) and Jₘ(bx) to be the following:

<Jₘ(ax),Jₘ(bx)>=∫₀¹xJₘ(ax)Jₘ(bx)dx (4)

Furthermore, the Fourier transform of the Bessel function is the following:

$$ℱ \{ {J}_{m} ( t ) \} = \frac{2 {( - i )}^{m} {T}_{m} ( 2 π f )}{\sqrt{1 - 4 {π}^{2} {f}^{2}}} rect ( π f ) \qquad ( 5 )$$

where Tₘ(t) is the Chebyshev polynomial of the first kind. Clearly, the Bessel function is a band-limited signal, which makes it a suitable function for the purposes of communications. Notice that the band limit is independent of the order m, but varies with different values of aᵢ in Jₘ(aᵢt).

### 8 DETAILED DESCRIPTION OF THE INVENTION

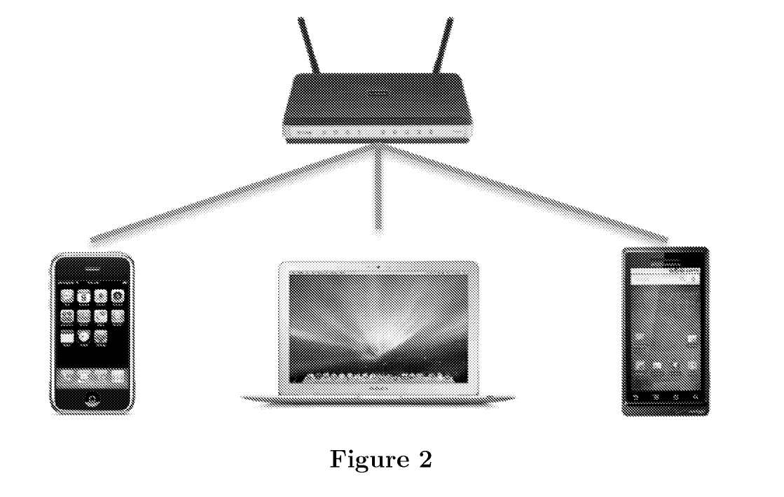

The present invention provides two different techniques in which the Bessel functions are exploited in modulating and encrypting signals in a wireless communications system. The system model includes a multiple of users wanting to communicate with a single access point, as is shown in FIG. 2. In essence, the orthogonality properties of the Bessel functions (equations (2) and (3)) lay the basis for multiplexing the wireless signals, and the encryption feature is merely a natural consequence of such a multiplexing scheme.

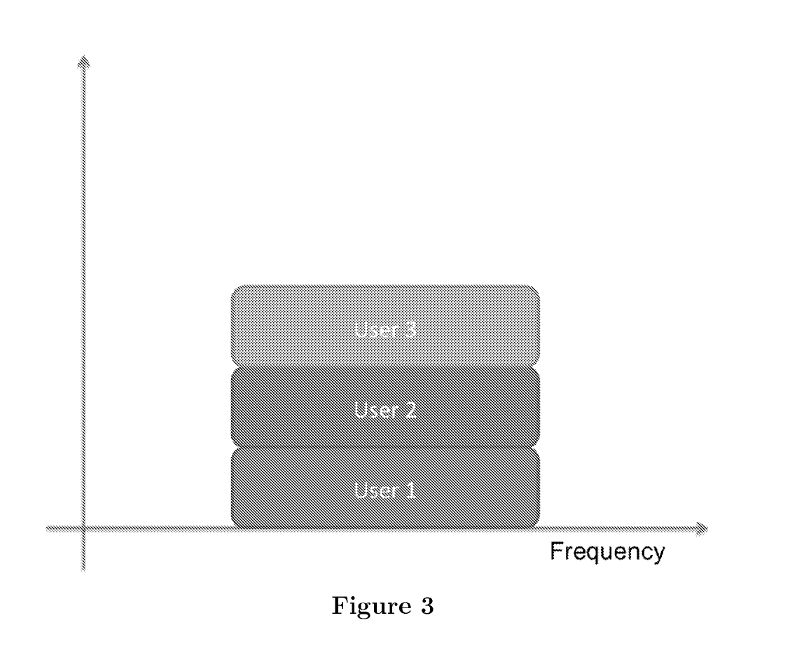

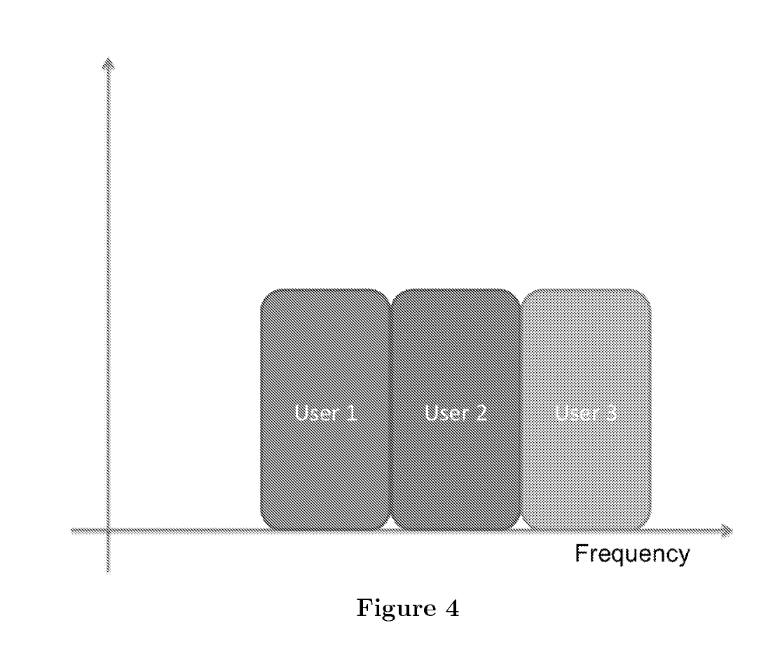

I will present two approaches to exploiting the Bessel functions: one where users share the same frequency band and one in which each user is assigned a separate frequency band (FIG. 3 and FIG. 4, respectively). The approaches will be discussed for the uplink (the arguments for the downlink are similar).

### 8.1 Approach 1: Shared Frequency Band

Suppose we have n users wanting to communicate with an access point, where each user i wants to send the symbol sᵢ (i=1, n). Since all the users are sharing the same frequency band, the system would first have to determine the order m of the Bessel function it would like to utilize. The reason is that the orthogonality properties of the Bessel functions (equations (2) and (3)), which allow for signal multiplexing, only hold when the two vectors have the same order m. The system then assigns each user a unique root a, based on that order (Jₘ(aᵢ)=0). The roots will be chosen such that the system meets its specified frequency band limitation (see (5)). Each user would then modulate and send its signal (during the specified timeframe of the system) as follows:

xᵢ(t)=sᵢJₘ(aᵢt) (6)

Assuming a perfect channel, the access point will receive

$$\begin{matrix}y ( t ) = {\sum }_{i = 1}^{n} {x}_{i} ( t ) \\ = {s}_{1} {J}_{m} ( {a}_{1} t ) + {s}_{2} {J}_{m} ( {a}_{2} t ) + … + {s}_{n} {J}_{m} ( {a}_{n} t )\end{matrix} \qquad ( 7 )$$

Utilizing equations (2), (3) and (4), we can obtain the symbol sᵢ from user i by the following computation:

$${s}_{i} = \frac{< y ( t ) , {J}_{m } ( {a}_{i} t ) >}{\frac{1}{2} {J}_{m + 1}^{2} ( {a}_{i} )} \qquad ( 8 )$$

Of course, this technique can be generalized to having each user send more than one symbol per timeframe. In this case, the user would simply choose more than one unique root a, to modulate its symbols:

xᵢ(t)=sᵢ¹Jₘ(aᵢ¹t)+sᵢ²Jₘ(aᵢ²t)+sᵢ³Jₘ(aᵢ³t)+ . . . (9)

### Encryption:

A user can encrypt its symbol by choosing a root a, for which only the user and access point have knowledge of. As can be seen in FIG. 1, there are an infinite number of roots the user can choose from for any order Tn. Of course, the roots must be chosen such that the bandwidth limitation of the system is met, according to (5). Furthermore, no two users can share the same root since the receiver would no longer be able to multiplex their signals.

### 8.2 Approach 2: Separate Frequency Bands

Consider the same system as before, with n users wanting to communicate with a single access point. In this approach, each user sends 2 k symbols and is only allowed to communicate on its own separate frequency band (FDM). The system can now assign a different order mᵢ to each user, which adds to the encryption robustness. Therefore, each user would modulate its symbols with the roots aᵢ^{j} (user i, root j) corresponding to its order mᵢ.

User i will now transmit the following:

xᵢ(t)={sᵢ¹Jₘ_{ᵢ}(aᵢ¹t)+sᵢ²Jₘ_{ᵢ}(aᵢ²t)+ . . . sᵢ^{k}Jₘ_{ᵢ}(aᵢ^{k}t)}·cos(ƒᵢt)+{sᵢ^{k+1}Jₘ_{ᵢ}(aᵢ^{k+1}t)+sᵢ^{k+2}Jₘ_{ᵢ}(aᵢ^{k+2}t)+ . . . sᵢ^{2k}Jₘ_{ᵢ}(aᵢ^{2k}t)}·sin(ƒᵢt) (10)

After downconverting and separating the in-phase and quadrature components, the access point would use (8) to extract the symbols.

### Encryption:

As opposed to Approach 1, where each user was limited to selecting a unique root aᵢ for encrypting its symbol, in Approach 2 users can select the order m that they want to utilize (which need not be unique) in addition to selecting the roots with respect to m in order to encrypt their symbols. This approach clearly yields a higher degree of robustness in the encryption, since an eavesdropper would need much more information (the order m as well as the corresponding roots a, the user has chosen) in order to decrypt the signal.

The previous section assumed an ideal channel. But what if our channel is not ideal? The wireless channel is a good example of this, where effects such as path-loss, shadowing, and multi-path fading require us to model the channel effectively in order to achieve acceptable performance.

Suppose we would like to characterize a linear and time-invariant communications channel for the complete system of orthogonal basis {ƒ(j,t)}, where j denotes the function element in the set and t is time. We have

$$\{ \begin{matrix}< f ( m , t ) , f ( n , t ) >= 0 & if m \neq n \\ < f ( m , t ) , f ( n , t ) >= 1 & if m = n\end{matrix} \qquad ( 11 )$$

where <ƒ(m,t), ƒ(n,t)> denotes the inner product of ƒ(m,t) and ƒ(n,t)

Recall that with sinusoids, every element in the set of functions undergoes attenuation and delay when passed through a channel. In general, however, orthogonal bases also experience distortion due to cross-talk between the elements in the set (in addition to experiencing attenuation and delay). In mathematical terms, if we input the function ƒ(i,t) into a channel, the output g(i,t) will be of the form

$$\begin{matrix}g ( i , t ) = {\sum }_{j = 0}^{∞} {k}_{j , i} f ( j , t - {t}_{i} ) \\ where & ( 12 ) \\ {k}_{j , i} = < g ( i , t ) , f ( j , t - {t}_{i} ) > & ( 13 )\end{matrix}$$

and the delay tᵢ is chosen such that the value of k_{i,i} is maximized. Doing so will reduce the cross-talk we see in other channels and will place more weight on the function element that we input to the channel. Nonetheless, for the purposes of simplicity, we will assume in this paper that tᵢ is chosen to be zero for all i. Thus, g(i,t) represents the response of the channel to the function element ƒ(i,t)

Now suppose that we wish to transmit the symbols sᵢ for i=0, 1, 2, . . . , n−1 by modulating them with the orthogonal basis in (11). Denoting the transmitted signal as x(t) and the received signal as y(t) we have

x(t)=s₀ƒ(0,t)+s₁ƒ(1,t)+s₂ƒ(2,t)+ . . . +sₙ₋₁ƒ(n−1,t) (14)

y(t)=s₀g(0,t)+s₁g(1,t)+s₂g(2,t)+ . . . +sₙ₋₁g(n−1,t) (15)

It can be shown that the symbols sᵢ can be retrieved from the received signal y(t) as follows:

$$[ \begin{matrix}{s}_{0} \\ {s}_{1} \\ {s}_{2} \\ ⋮ \\ {s}_{n - 1}\end{matrix} ] = {[ \begin{matrix}{k}_{0 , 0} & {k}_{0 , 1} & {k}_{0 , 2} & … & {k}_{0 , n - 1} \\ {k}_{1 , 0} & {k}_{1 , 1} & {k}_{1 , 2} & … & {k}_{1 , n - 1} \\ {k}_{2 , 0} & {k}_{2 , 1} & {k}_{2 , 2} & … & {k}_{2 , n - 1} \\ ⋮ & ⋮ & ⋮ & ⋮ & ⋮ \\ {k}_{n - 1 , 0} & {k}_{n - 1 , 1} & {k}_{n - 1 , 2} & … & {k}_{n - 1 , n - 1}\end{matrix} ]}^{- 1} [ \begin{matrix}< y ( t ) , f ( 0 , t ) > \\ < y ( t ) , f ( 1 , t ) > \\ < y ( t ) , f ( 2 , t ) > \\ ⋮ \\ < y ( t ) , f ( n - 1 , t ) >\end{matrix} ] \qquad ( 16 )$$

where the matrix K represents the response of the channel to the set of orthogonal basis in (11). It is clear that the same approach can be taken in demodulating the Bessel functions by replacing the orthogonal basis in (11) with that of the Bessel set.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A communication system comprising the steps of:
a modulating signals using the Bessel functions.
b encrypting signals by means of modulating them using the Bessel functions.
